(19) United States
(12) Patent Application Publication
(10) Pub. No.: US 2024/0160813 A1
(43) Pub. Date: May 16, 2024

(54) ADAPTIVE TUNING OF PHYSICS-BASED DIGITAL TWINS

(71) Applicant: Siemens Aktiengesellschaft, Munich (DE)

(72) Inventor: Joseph Tylka, Pennington, NJ (US)

(73) Assignee: Siemens Aktiengesellschaft, Munich (DE)

(21) Appl. No.: 18/282,252

(22) PCT Filed: May 27, 2021
(86) PCT No.: PCT/US2021/034460

§ 371 Date: Sep. 15, 2023

(51) Int. Cl. G06F 30/27; G06F 111/10

(52) U.S. Cl. CPC G06F 30/27; G06F 2111/10

(57) ABSTRACT

A computer-implemented method is disclosed for automatically tuning a digital twin of a physical system (302) that utilizes a physics-based model (304) of the physical system (302). The method uses a trained mapping (308) between a physics-based parameter set of the physics-based model (304) and a filter coefficient set of an adaptive filter (306) applied to the physical system (302). An adaptive filtering-based approach is used to update the filter coefficient set at discrete time steps based on an error between an output signal measured from the physical system (302) in response to an input signal and an output response computed by the physics-based model (304) for the same input signal. The trained mapping (308) is then used to determine updated parameter values in the physics-based parameter set from the updated filter coefficient set. The method may be used to adapt a digital twin simulation at runtime to closely match the behavior of a physical system (302).

### TECHNICAL FIELD

The present disclosure relates generally to the field of physics-based digital twins. Described embodiments are directed to a technique for automatically tuning physics-based model parameters of a digital twin efficiently at runtime to closely match the behavior of a real world physical system.

### BACKGROUND

Simulation technologies are widely used, for example, for predicting behavior of real world objects or for explaining behavior of past events. An exemplary application of simulation technology is in digital twins.

Increasingly, engineering tools for automation systems may embed a digital twin of the real world. At the core of the digital twin representation of the real world is a physics engine (e.g. Bullet™, Mujoco™, among others) that utilizes a physics-based model of a real world physical system. One of the challenges associated with a digital twin simulation is a discrepancy between an observed output in the real world and a corresponding output for the same input signal obtained by the physics-based model. Often, this discrepancy arises due to inaccuracies in the parameters used in the physics-based model, herein referred to as “physics-based parameters.”

Typically, physics-based parameters are computed offline, for example, using cloud computing systems or computing clusters performing global or local optimization tasks. This is often required since the relationship between the physics-based parameters and the output of the physics-based model may be highly nonlinear, non-convex, or otherwise mathematically complicated. Consequently, determining the correct parameter values which describe the behavior of a real world physical system accurately is often too computationally expensive to be run on an edge computing device or to keep up with real-time.

### SUMMARY

Briefly, aspects of the present disclosure provide a technique that enables physics-based parameters of a digital twin to be efficiently updated on-the fly to closely match the behavior of a physical system. The technique provides faster convergence of parameter values that match real data.

According to a first aspect, a computer-implemented method is provided for automatically tuning a digital twin of a physical system. The digital twin utilizes a physics-based model of the physical system defined by a physics-based parameter set. The method comprises obtaining a trained mapping between the physics-based parameter set and a filter coefficient set of an adaptive filter applied to the physical system, initializing the physics-based parameter set and the filter coefficient set, and using adaptive filtering over a series of discrete time steps iteratively to converge on filter coefficients, and mapping those converged filter coefficients to parameter values in the physics-based parameter set. Each iteration comprises: computing, by the physics-based model, an output response to a measured physical input signal using current parameter values in the physics-based parameter set; measuring, from the physical system, an output signal produced in response to the physical input signal, and determining an error signal based on the measured output signal and the computed output response; updating the filter coefficient set as a linear function of the error signal; and determining updated parameter values in the physics-based parameter set from the updated filter coefficient set using the trained mapping.

According to a further aspect, a computer-implemented method is provided that uses the above-described technique for adapting a simulation of a physical system by a digital twin at runtime, wherein the digital twin utilizes a physics-based model of the physical system defined by a physics-based parameter set. The method comprises operating a controllable device of the physical system to execute a process by generating control signals that act on the controllable device to produce a physical input signal to the physical system, and updating parameter values in the physics-based parameter set at discrete time steps during the execution of the process by the controllable device according to the above-described technique. The method uses the updated parameter values determined at each time step to carry out a simulation of the physical system by the digital twin utilizing the physics-based model, until a next update of the parameter values is determined at a subsequent time step during the execution of the process by the controllable device.

Other aspects of the present disclosure implement features of the above-described methods in a computer program product, a computing apparatus and an automation system.

Additional technical features and benefits may be realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The foregoing and other aspects of the present disclosure are best understood from the following detailed description when read in connection with the accompanying drawings. To easily identify the discussion of any element or act, the most significant digit or digits in a reference number refer to the figure number in which the element or act is first introduced.

FIG. 1 illustrates an automation system according to an example embodiment.

FIG. is a schematic illustration of a standard adaptive filter.

FIG. 3 is a schematic illustration of functional blocks of a system using an adaptive filtering-based technique to update physics-based parameters of a digital twin, according to an example embodiment.

FIG. 4 is a flowchart illustrating a computer-implemented method for automatically adapting a digital twin of a physical system at runtime according to an example embodiment.

FIG. 5 is a flowchart illustrating a computer-implemented method for creating a synthetic dataset for training a mapping between a physics-based parameter set and a filter coefficient set of an adaptive filter.

FIG. 6 illustrates a computing system in accordance with an aspect of the disclosure.

### DETAILED DESCRIPTION

Various technologies that pertain to systems and methods will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

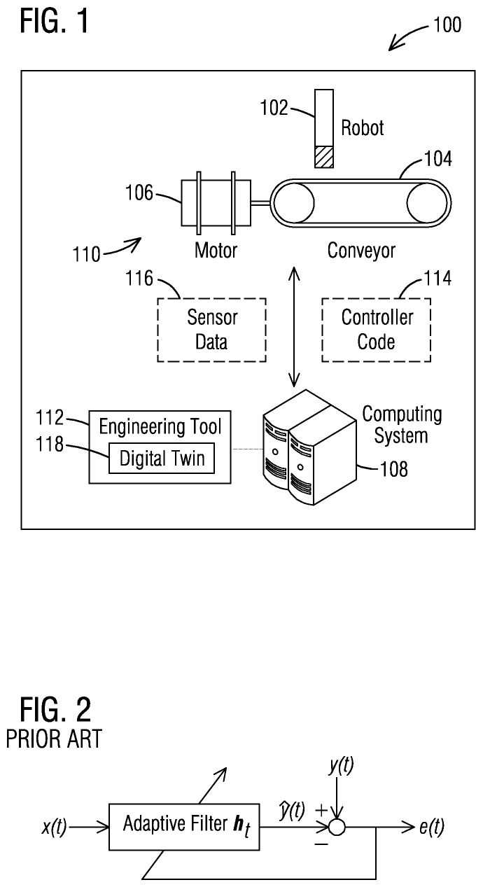

Referring now to FIG. 1, an exemplary automation system 100 is illustrated where aspects of the present disclosure may be embodied. The automation system 100 may be implemented, for example, at a production site. In some embodiments, the automation system 100 may be configured as an autonomous system. In contrast to conventional automation, autonomy gives each asset on the factory floor the decision-making and self-controlling abilities to act independently in the event of local issues. The term “automation system”, as used in this description, is intended to cover both conventional automation systems and autonomous systems. The automation system 100 comprises one or more physical devices, illustrative examples of which include a robot 102, a conveyor 104 and a motor 106. The one or more devices 102, 104, 106 are controllable by a computing system 108 to execute a process within a physical system 110.

The physical system 110 includes the one or more controllable devices 102, 104, 106 themselves, as well as the physical environment in which the process is executed by the device(s), which includes, for example, the design or layout of the cell, workpieces handled by the device(s), tools (e.g., fixtures, grippers, etc.), among others. A physical system, in general, is defined as a system capable of producing a measurable response to a physical input signal. The physical input signal could be, for example, a mechanical input (e.g., force, torque, etc.), an electrical input (e.g. voltage or current), a thermal input (e.g., temperature of deposited material in an additive manufacturing process), or any combinations thereof.

The computing system 108 may comprise, for example, an industrial PC, or any other computing device, such as a desktop or a laptop, among others, which may be configured to execute an application program for operating one or more controllable devices. In the described embodiment, the application program is embodied in an engineering tool 112.

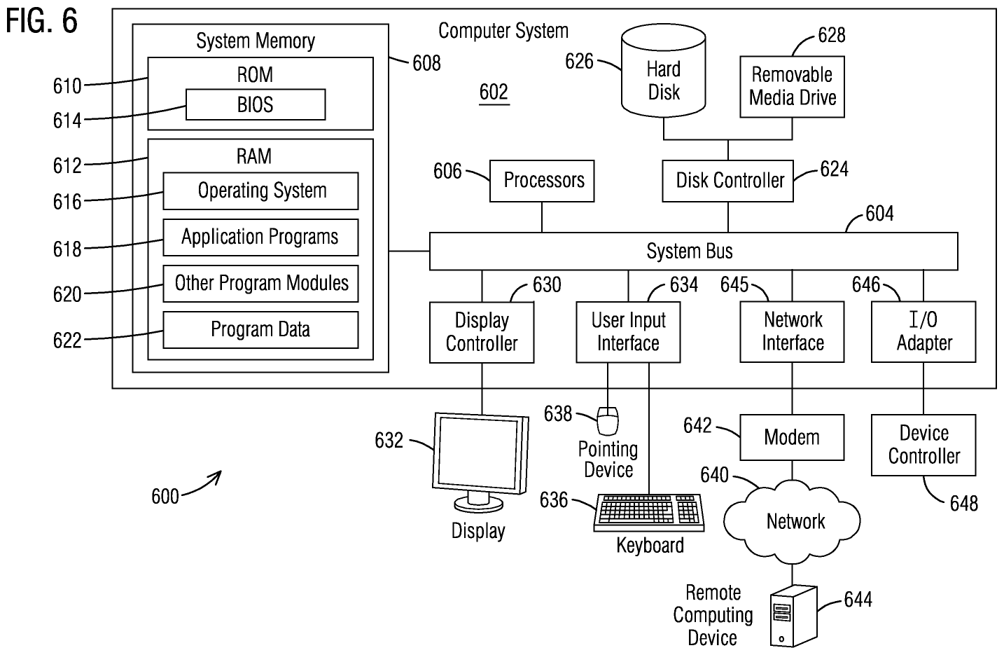

The engineering tool 112 may generate controller code 114 for controlling the one or more devices 102, 104, 106, to as such control the physical input signal to the physical system 110. In one embodiment, the controller code 114 may define high-level instructions to execute a specified process. The controller code 114 may be deployed to respective device controllers, which generate low-level control signals for the one or more controllable devices 102, 104, 106, to provide the physical input to execute the specified process. The device controllers may be embedded in the respective devices. In some embodiments, the controller code 114 generated by the engineering tool 112 may be deployed to intermediate control equipment, such as programmable logic controllers (PLC), which may then generate low-level control commands for the physical device(s) to be controlled. Additionally, the engineering tool 112 may be configured to directly integrate sensor data 116 from physical system 110 in which the devices 102, 104, 106 operate. To this end, the computing system 108 may comprise a network interface to facilitate transfer of live data between the engineering tool 112 and the physical system 110. An example of a computing system suitable for the present application is described hereinafter in connection with FIG. 6.

Continuing with reference to FIG. 1, embedded in the engineering tool 112 is a digital twin 118 of the real world physical system 110, which may be used to obtain a digital representation of a state of the physical environment in which the one or more devices 102, 104, 106 operate. The digital twin 118 may comprise a high-fidelity model of the physical system 110, which may utilize, for example, CAD models representing physical objects in the operating environment of the one or more devices 102, 104, 106 (including the devices themselves). In other embodiments, instead of or in addition to employing CAD models, sensor data, such as imaging data, may be utilized to generate digital representations of the physical objects. The digital twin 118 further includes a physics engine configured to execute a simulation of the physical system for a process being executed by the one or more controllable devices 102, 104, 106.

The physics engine includes a physics-based model that captures the main physical relationships between objects in the physical environment and can enable both co-simulation and forward simulations. Co-simulation refers to a simulation of the real world physical system 110 executed in parallel as the one or more controllable devices 102, 104, 106 execute a physical process. Ideally, a co-simulation should reflect the exact state of the physical system 110 at any given instant. The automation system 100 may query the co-simulation from time to time, for example, to obtain information about things that cannot be measured or observed directly from the physical environment. A forward simulation refers to a forecasting of the dynamics of the physical system 110 consequent to a task or action to be executed by the one or more controllable devices 102, 104, 106, starting from a given world state.

One of the purposes of the digital twin 118 is to serve as a belief representation to the automation system 100. The system can use this representation of the real world to reason about the actions of the devices being controlled and their effects on the physical system 110. Trying out actions in the belief space is convenient for finding the right action to apply it in the real world. For example, the digital twin 118 can use forward simulations to evaluate which force would be required to push an object on a table (e.g., by robot 102) for the object to reach a desired position (for e.g., to be arranged next to the other objects on the table). In this example, the relevant physics effects are rigid body motion, contact dynamics and friction. Many physical relationships can be captured well by the physics-based model by first order modelling up to certain parameters. For example, although Coulomb's law describes friction forces, a friction coefficient needs to be specified, which depends, amongst other factors, on the material pairing. In order for the engineering tool 112 to be useful, it is desirable to capture not only the physical laws well enough, but also set all physics-based parameters according to the situation in which the one or more controllable devices are acting. Inaccuracies in the physics-based parameter values may lead to discrepancies between the simulation and the real world. Unfortunately, many of the physics-based parameters (e.g., friction coefficient) cannot be observed or measured directly from the real world physical system.

Aspects of the present disclosure enable a digital twin to automatically synchronize its underlying physics-based model, and in particular, the physics-based parameters, to closely match the real world physical system. This is achieved by (i) introducing a trained mapping between an abstract linear parameter space and the native physics-based parameters, and (ii) using an adaptive filtering-based technique to optimally update the linear parameters (i.e., filter coefficients of an adaptive filter) as a linear function of an error signal. A key feature is the construction of an abstract “linear” parameter space, which can be quickly and easily updated on-the-fly based on a simple error signal calculation. This provides a significant improvement in computational efficiency and enables highly complex physics-based digital twins to be adapted online to match real-world data. Such a method is an enabler to bring high-fidelity physics-based digital twins into runtime or edge computing systems with limited computing resources and hard real-time performance requirements.

Adaptive filtering is a technique widely used in signal processing and is well suited to making fast changes to the filter coefficients based on system response (i.e., measured signals from the physical environment). An example of a standard algorithm for adaptive filtering is briefly described at the outset referring to FIG. 2.

Generally, we consider an input signal x(t) to a linear system, described by its impulse response h(t), which produces an output response ŷ(t) as given by:

ŷ(t)=(h*x)t (1)

where “*” denotes a convolution operation.

The actual output response y(t) of a physical system to the input signal x(t) is given by:

y(t)=ŷ(t)+e(t) (2)

where e(t) represents error or noise.

To build a model of the system, an adaptive filtering algorithm is used to adaptively estimate h. Several adaptive filtering algorithms are currently known, one example of which is the normalized least mean square algorithm. Here, the order or length of the filter h is denoted by p. The vector of filter coefficients (filter coefficient set) at each time step t is denoted by:

hₜ=[hₜ(0),hₜ(1) . . . hₜ(P−1)] (3)

The algorithm is initialized with:

h₀(τ)=0,∀τ∈[0,p−1],

x(t)=0,∀t<0, (4)

At each time step t, samples of the error signal e(t) are iteratively computed and the filter coefficients h t are simultaneously updated based on the following:

$${x}_{t} = [ x ( t ) , x ( t - 1 ) … x ( t - p + 1 ) ] , \qquad ( 5 )$$

$$e ( t ) = y ( t ) - {h}_{t} \cdot {x}_{t} ,$$

$${h}_{t + 1} = {h}_{t} + \frac{μ e ( t )}{{x}_{t} \cdot {x}_{t}} {x}_{t}$$

In equations (5), μ is a predefined step size. Since xₜ has been time reversed, the convolution of h and x is represented as an inner (dot) product.

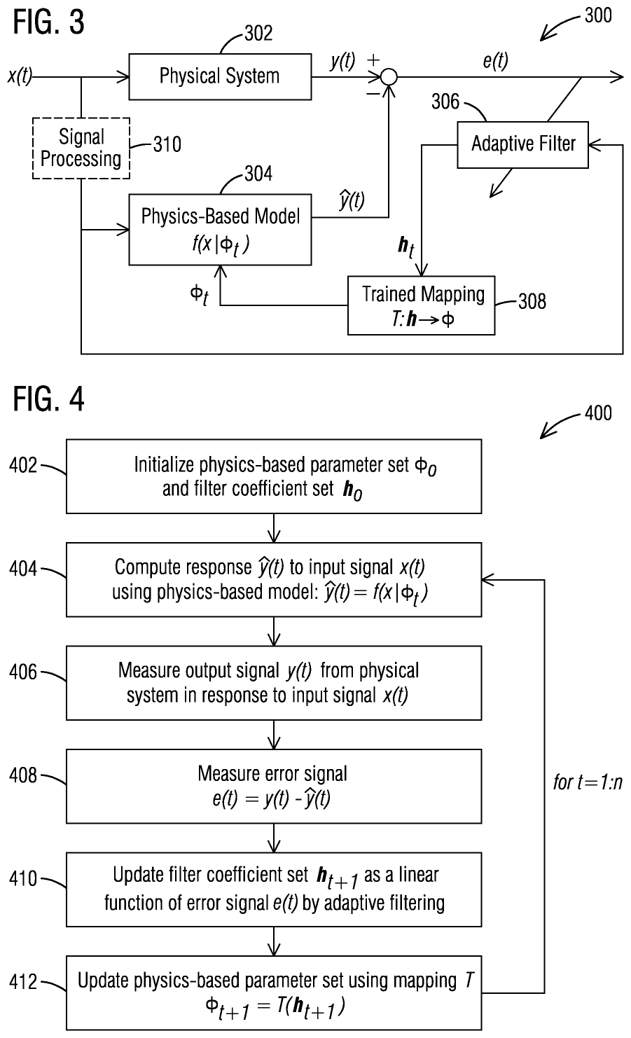

FIG. 3 illustrates functional blocks of a system 300 according to one embodiment of the disclosure, which uses an adaptive filtering-based technique to update the physics-based parameters of a digital twin. Here, a physical input signal x(t) is provided to a physical system 302. As described earlier, the input signal x(t) may be provided by generating control signals that act on one or more controllable devices of the physical system 302. The physical system 302 produces a response y(t), which is measured at each time step t, for example by one or more sensors. The input signal x(t) is also measured (e.g., by sensors) and provided to a physics-based model 304 of the physical system 302. The measured input signal x(t) from the real-world may be preprocessed by a signal processing module 310 prior to being input to the physics-based model 304. The physics-based model 304 produces an output response ŷ(t) given by:

ŷ(t)=ƒ(x|Φₜ) (6)

where Φₜ represents the physics-based parameter set having parameter values that are current for time step t.

An adaptive filter 306 is used to update, at each time step t, the filter coefficient set hₜ as a function of an error signal e(t) that describes a discrepancy between measured output y(t) of the physical system 302 and the predicted output ŷ(t) of the physics-based model 304.

The described system utilizes a trained mapping 308 (T:h→Φ) that maps the filter coefficient set hₜ to the physics-based parameter set Φₜ which is used by the physics-based model 304. The mapping T is used to update the physics-based parameter set cto t at each time step t, based on the updated filter coefficient set h t computed by the adaptive filter 306. When fully trained, T will ensure that hₜ·xₜ≈ƒ(x|Φ)=ŷ(t) for all Φ. This implies that, for a given Φ=Φ₀, the system described by the impulse response h t is precisely the linear approximation of ƒ in the vicinity of Φ₀.

A distinct feature of the present embodiment, in relation to a standard adaptive filtering technique illustrated in FIG. 2, is the introduction of the physics-based model 304 into the loop. The filter coefficients h t may be updated according to any adaptive filtering technique (e.g., normalized least square algorithm). However, in the present case, the signal ŷ(t) is computed by the physics-based model 304, unlike in the standard algorithm described above where it was computed as a convolution of the impulse response function and input signal (see equation. (1)). Accordingly, after each time step t, the latest estimate of the filter coefficient set hₜ₊₁ computed by the adaptive filter 306 is run through the mapping 306 to compute the new or updated physics-based parameter set Φₜ₊₁, which is fed to the physics-based model 304, along with the current input signal, to compute the output response and the error signal.

FIG. 4 is a flowchart illustrating a computer-implemented method 400 for automatically adapting a digital twin of a physical system at runtime according to an example embodiment. FIG. 4 is not intended to indicate that the operational blocks of the method 400 are to be executed in any particular order, or that all of the blocks of the method 400 are to be included in every case. Additionally, the method 400 can include any suitable number of additional operations. The method 400 is computer-implemented, meaning that the steps (or substantially all the steps) of the method 400 are executed by at least one computer, or any system alike. The method 400 may be better understood referring jointly to FIGS. 3 and 4.

The method 400 uses a trained mapping T between the physics-based parameter set and the filter coefficient set of an adaptive filter applied to the physical system. In various embodiments, physics-based parameter set may comprise at least one physics-based parameter that is not directly measurable from the physical system. The length or order p of the filter coefficient set may be determined, for example, based on factors such as: the degrees of freedom defined by the number of independent physics-based parameters, the time constant of the slowest component of the physical system (to accurately capture time dependencies), among others. The mapping T may be created offline, for example, in a cloud or distributed computing environment, and subsequently deployed to a runtime system. In one embodiment, the runtime system may be implemented in an edge computing platform. “Edge computing” refers to a computing paradigm where computing is carried out outside the cloud, at the edge of a network, typically in applications where real-time processing of data is needed, to improve response time and/or save bandwidth.

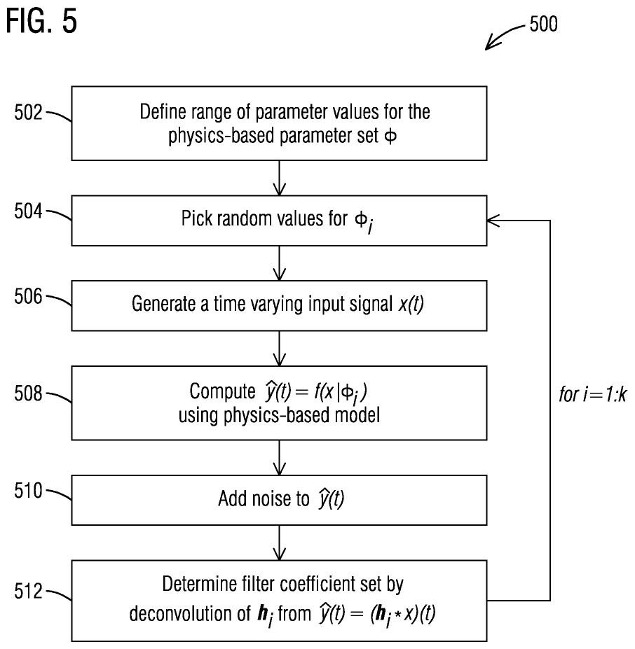

At operational block 402, the physics-based parameter set and the filter coefficient set are initialized with initial values Φ₀ and h₀ respectively. Initial parameter values in the physics-based parameter set may be defined, for example, based on domain-specific knowledge. The state-of-the-art physics engines already work with user-specified values of the physics-based parameters. In an example embodiment, the initial parameter values in the physics-based parameter set may be defined based on such existing user-specified values, whereby the present technique would provide a simple means to upgrade an existing physics simulation engine. Given a user-specified Φ₀, h₀ may be computed by a deconvolution of a time-varying input signal from a response signal to this input signal computed by the physics-based model (using the initialized physics-based parameter set Φ₀). This methodology is discussed in greater detail referring to FIG. 5.

Continuing with reference to FIG. 4, the method 400 involves iteratively executing operational blocks 404 through 412 for each time step t, over a series of n time steps, to converge on filter coefficients, and mapping those converged filter coefficients to parameter values in the physics-based parameter set. The frequency of the execution time steps may be set to be lower than the sampling frequency depending on the computational requirements, especially running the mapping T. In some embodiments, the frequency of the execution time steps may equal the sampling frequency, allowing the physics-based parameters to be updated substantially in real-time. The number of iterations n may be a predefined value, or may be determined as a function of one or more exit criteria depending on a desired degree of convergence. In some embodiments, the method 400 may comprise additional blocks that define such exit criteria. In an example embodiment, the exit criteria may be configured to pause and resume the adaptive filtering process to update the physics-based parameters as a function of the error signal.

Operational block 404 involves computing a response ŷ(t) to a measured physical input signal x(t) by the physics-based model, using equation (6).

Operational block 406 involves measuring an output signal y (t) from the real world physical system in response to the physical input signal x(t).

Operation block 408 involves determining an error signal e(t):

e(t)=y(t)−ŷ(t) (7)

Operational block 410 involves using an adaptive filtering algorithm to update the filter coefficient set as a linear function of the error signal e(t). In one embodiment, the step of updating the filter coefficient set is based on minimizing a mean square of the error signal e(t), for example, using the above-described equation

$${h}_{t + 1} = {h}_{t} + \frac{μ e ( t )}{{x}_{t} \cdot {x}_{t}} {x}_{t} .$$

By updating the filter coefficient set over multiple iterations based on the above relationship, the solution converges to a least mean square error. Larger values of the step-size μ causes the filter to converge faster but can also cause instability. Typically, for stability in the filter updates, it may be desirable to choose μ∈(0, 1), e.g., μ˜0.9.

Operational block 412 involves updating the physics-based parameter set based on the updated filter coefficient set using the mapping T, as given by:

Φₜ₊₁=T(hₜ₊₁) (8)

The above-described method provides significantly faster execution time in comparison to state-of-the-art non-convex optimization algorithms, which are too computationally expensive to be run on an edge computing device or to keep up with real-time. Furthermore, unlike the state-of-the-art optimization algorithms, the above-described method does not require a deterministic search for a global minimum in the optimization space, which may or may not even converge. The computational efficiency of the above-described method makes it particularly suitable for edge computing devices and other real-time applications.

In a further embodiment, the above-described technique may be used for automatically adapting a digital twin co-simulation of a physical system at runtime. The method comprises operating one or more controllable devices of the physical system to execute a process. In some embodiments, as previously described, the process may be executed based on physical input signals provided to the physical system via the one or more controllable devices based on control signals communicated by device controllers, which in turn, are derived from high-level controller code generated by an engineering tool running on a computer system. The method includes updating parameter values in the physics-based parameter set at discrete time steps during the execution of the process by the one or more controllable devices according to the above-described technique. The method further uses the updated parameter values determined at each time step to carry out a simulation of the physical system by the digital twin utilizing the physics-based model, until a next update of the parameter values is determined at a subsequent time step during the execution of the process by the one or more controllable devices.

In still further embodiments, the updated physics-based parameter set may be used to generate forward simulations by the digital twin of the physical system for a process to be executed in future.

In one embodiment, the mapping T is created using a synthetic training dataset comprising a large number of data samples, where each data sample comprises a pairing of the physics-based parameter set and the filter coefficient set. The data samples are created over a predetermined range of parameter values in the physics-based parameter set. A synthetic dataset allows an arbitrarily large number of data samples to be created independent of the physical system, in order to suitably create the mapping T, for example through deep learning. An example method for creating a synthetic dataset is illustrated referring to FIG. 5.

FIG. 5 is a flowchart illustrating a computer-implemented method 500 for creating a synthetic dataset for training a mapping T between a physics-based parameter set and a filter coefficient set of an adaptive filter. FIG. 5 is not intended to indicate that the operational blocks of the method 500 are to be executed in any particular order, or that all of the blocks of the method 500 are to be included in every case. Additionally, the method 500 can include any suitable number of additional operations. The method 500 is computer-implemented, meaning that the steps (or substantially all the steps) of the method 500 are executed by at least one computer, or any system alike.

Operational block 502 of the method 500 includes defining a range of parameter values for each parameter in the physics-based parameter set Φ. The range of values may include a practically reasonable range for each parameter, for example, obtained from a domain or model expert.

Each data sample is then synthesized by executing operational blocks 504 through 512, whereby blocks 504 through 512 are repeated for k data samples in the dataset. As mentioned above, the value of k can be arbitrarily large, to adequately explore the parameter space (of the physics-based parameters), allowing a sufficiently large dataset to be created for training the mapping T. Each loop of the method 500 yields a unique data pair Φᵢ, hᵢ defining one data sample.

Operational block 504 includes randomly selecting parameter values from the predetermined range of values, to define the physics-based parameter set Φᵢ.

Operational block 506 involves generating a time varying input signal x(t). In one embodiment, the time varying input signal x(t) comprises a sine-sweep signal, to effectively excite a substantial portion of the frequency range, so as to obtain a large number of salient data points in the input signal. In another embodiment, the time varying input signal x(t) may comprise a white noise signal.

Operational block 508 comprises plotting a response y(t) to the time varying input signal x(t) that is computed by the physics-based model using the randomly selected physics-based parameter set Φᵢ. This operation may be denoted as:

ŷ(t)=ƒ(xt|Φᵢ) (9)

Operational block 510 includes an optional step of adding a noise signal e(t) to the computed response ŷ(t) to the time varying input signal x(t).

Finally, operational block 512 comprises determining the filter coefficient set hᵢ of the data sample based on a deconvolution of the time varying input signal x(t) from the computed response ŷ(t) to the time varying input signal. In other words, this operation involves deconvolving hᵢ from the following equation:

ŷ(t)=(hᵢ*x)(t) (10)

Deconvolution may be performed by computing the Fourier transform of the signals x(t) and ŷ(t). The input signal generation and deconvolution operations may be performed, for example, according to standard methods of linear system identification.

Having created the training data pairs Φᵢ, hᵢ, the next step is to train and validate a mapping T using the dataset. The mapping T:h→Φ may comprise a deep learning model or any other mathematical or statistical model, which may be trained to determine parameter values in the physics-based parameter set based on an input filter coefficient set.

In an exemplary embodiment, the mapping T is implemented using a neural network. Here, a first portion of the dataset may be used for training the untrained (skeleton) neural network in a supervised learning regime and a second portion of the dataset may be used for testing or validating the trained neural network. The supervised learning regime involves repeated adjustments of parameters (weights, biases) of the neural network via back propagation utilizing the training data and associated classification labels. After the completion of the supervised learning, the resultant trained neural network may be tested or validated using unlabeled test data. Testing the trained neural network may be done, for example, to identify and correct overfitting of the neural network.

FIG. 6 illustrates an exemplary computing environment comprising a computing system 602, within which aspects of the present disclosure may be implemented. The computing system 602 may be embodied, for example and without limitation, as an industrial PC for controlling a robot of an autonomous system. Computers and computing environments, such as computing system 602 and computing environment 600, are known to those of skill in the art and thus are described briefly here.

As shown in FIG. 6, the computing system 602 may include a communication mechanism such as a system bus 604 or other communication mechanism for communicating information within the computing system 602. The computing system 602 further includes one or more processors 606 coupled with the system bus 604 for processing the information. The processors 606 may include one or more central processing units (CPUs), graphical processing units (GPUs), or any other processor known in the art.

The computing system 602 also includes a system memory 608 coupled to the system bus 604 for storing information and instructions to be executed by processors 606. The system memory 608 may include computer readable storage media in the form of volatile and/or nonvolatile memory, such as read only memory (ROM) 610 and/or random access memory (RAM) 612. The system memory RAM 612 may include other dynamic storage device(s) (e.g., dynamic RAM, static RAM, and synchronous DRAM). The system memory ROM 610 may include other static storage device(s) (e.g., programmable ROM, erasable PROM, and electrically erasable PROM). In addition, the system memory 608 may be used for storing temporary variables or other intermediate information during the execution of instructions by the processors 606. A basic input/output system 614 (BIOS) containing the basic routines that help to transfer information between elements within computing system 602, such as during start-up, may be stored in system memory ROM 610. System memory RAM 612 may contain data and/or program modules that are immediately accessible to and/or presently being operated on by the processors 606. System memory 608 may additionally include, for example, operating system 616, application programs 618, other program modules 620 and program data 622.

The computing system 602 also includes a disk controller 624 coupled to the system bus 604 to control one or more storage devices for storing information and instructions, such as a magnetic hard disk 626 and a removable media drive 628 (e.g., floppy disk drive, compact disc drive, tape drive, and/or solid state drive). The storage devices may be added to the computing system 602 using an appropriate device interface (e.g., a small computer system interface (SCSI), integrated device electronics (IDE), Universal Serial Bus (USB), or FireWire).

The computing system 602 may also include a display controller 630 coupled to the system bus 604 to control a display 632, such as a cathode ray tube (CRT) or liquid crystal display (LCD), among other, for displaying information to a computer user. The computing system 602 includes a user input interface 634 and one or more input devices, such as a keyboard 636 and a pointing device 638, for interacting with a computer user and providing information to the one or more processors 606. The pointing device 638, for example, may be a mouse, a light pen, a trackball, or a pointing stick for communicating direction information and command selections to the one or more processors 606 and for controlling cursor movement on the display 632. The display 632 may provide a touch screen interface which allows input to supplement or replace the communication of direction information and command selections by the pointing device 638.

The computing system 602 also includes an I/O adapter 646 coupled to the system bus 604 to connect the computing system 602 to a controllable physical device, such as a robot. In the example shown in FIG. 6, the I/O adapter 646 is connected to device controller 648. In one embodiment, the device controller 648 includes a robot controller, which includes, for example, one or more motors for controlling linear and/or angular positions of various parts (e.g., arm, base, etc.) of a robot.

The computing system 602 may perform a portion or all of the processing steps of embodiments of the disclosure in response to the one or more processors 606 executing one or more sequences of one or more instructions contained in a memory, such as the system memory 608. Such instructions may be read into the system memory 608 from another computer readable storage medium, such as a magnetic hard disk 626 or a removable media drive 628. The magnetic hard disk 626 may contain one or more datastores and data files used by embodiments of the present disclosure. Datastore contents and data files may be encrypted to improve security. The processors 606 may also be employed in a multi-processing arrangement to execute the one or more sequences of instructions contained in system memory 608. In alternative embodiments, hard-wired circuitry may be used in place of or in combination with software instructions. Thus, embodiments are not limited to any specific combination of hardware circuitry and software.

The computing system 602 may include at least one computer readable storage medium or memory for holding instructions programmed according to embodiments of the disclosure and for containing data structures, tables, records, or other data described herein. The term “computer readable storage medium” as used herein refers to any medium that participates in providing instructions to the one or more processors 606 for execution. A computer readable storage medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 626 or removable media drive 628. Non-limiting examples of volatile media include dynamic memory, such as system memory 608. Non-limiting examples of transmission media include coaxial cables, copper wire, and fiber optics, including the wires that make up the system bus 604. Transmission media may also take the form of acoustic or light waves, such as those generated during radio wave and infrared data communications.

The computing environment 600 may further include the computing system 602 operating in a networked environment using logical connections to one or more remote computers, such as remote computing device 644. Remote computing device 644 may be a personal computer (laptop or desktop), a mobile device, a server, a router, a network PC, a peer device or other common network node, and typically includes many or all of the elements described above relative to computing system 602. When used in a networking environment, computing system 602 may include a modem 642 for establishing communications over a network 640, such as the Internet. Modem 642 may be connected to system bus 604 via network interface 645, or via another appropriate mechanism.

Network 640 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computing system 602 and other computers (e.g., remote computing device 644). The network 640 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 640.

The embodiments of the present disclosure may be implemented with any combination of hardware and software. In addition, the embodiments of the present disclosure may be included in an article of manufacture (e.g., one or more computer program products) having, for example, a non-transitory computer-readable storage medium. The computer readable storage medium has embodied therein, for instance, computer readable program instructions for providing and facilitating the mechanisms of the embodiments of the present disclosure. The article of manufacture can be included as part of a computer system or sold separately.

The computer readable storage medium can include a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. Computer readable program instructions described herein can be downloaded to respective computing/processing devices from a computer readable storage medium or to an external computer or external storage device via a network, for example, the Internet, a local area network, a wide area network and/or a wireless network.

The system and processes of the figures are not exclusive. Other systems, processes and menus may be derived in accordance with the principles of the disclosure to accomplish the same objectives. Although this disclosure has been described with reference to particular embodiments, it is to be understood that the embodiments and variations shown and described herein are for illustration purposes only. Modifications to the current design may be implemented by those skilled in the art, without departing from the scope of the disclosure.

1. A computer-implemented method for automatically tuning a digital twin of a physical system, the digital twin utilizing a physics-based model of the physical system defined by a physics-based parameter set, the method comprising:
obtaining a trained mapping between the physics-based parameter set and a filter coefficient set of an adaptive filter applied to the physical system,
initializing the physics-based parameter set and the filter coefficient set, and
over a series of discrete time steps, iteratively performing at each time step:
computing, by the physics-based model, an output response to a measured physical input signal using current parameter values in the physics-based parameter set,
measuring, from the physical system, an output signal produced in response to the physical input signal, and determining an error signal based on the measured output signal and the computed output response,
updating the filter coefficient set as a linear function of the error signal, and
determining updated parameter values in the physics-based parameter set from the updated filter coefficient set using the trained mapping.

2. The method according to claim 1, wherein updating the filter coefficient set comprises minimizing a mean square of the error signal.

3. The method according to claim 1, wherein physics-based parameter set comprises at least one physics-based parameter that is not directly measurable from the physical system.

4. The method according to claim 1, further comprising creating the trained mapping using a synthetic training dataset comprising a plurality of data samples, wherein each data sample comprises a pairing of the physics-based parameter set and the filter coefficient set, the plurality of data samples being created over a predetermined range of parameter values in the physics-based parameter set.

5. The method according to claim 4, wherein each data sample of the training dataset is created by:
selecting random parameter values from the predetermined range to define the physics-based parameter set,
generating a time varying input signal and computing a response to the time varying input signal by the physics-based model using the physics-based parameter set defined by the selected random parameter values, and
determining the filter coefficient set based on a deconvolution of the time varying input signal from the computed response to the time varying input signal.

6. The method according to claim 5, wherein the time varying input signal comprises a sine sweep signal.

7. The method according to claim 5, further comprising adding a noise signal to the computed response to the time varying input signal prior to the deconvolution.

8. The method according to claim 4, wherein creating the trained mapping comprises training a neural network on the training dataset to determine parameter values in the physics-based parameter set based on an input filter coefficient set.

9. The method according to claim 4, wherein the trained mapping is created offline and subsequently deployed to a runtime system.

10. The method according to claim 9, wherein the trained mapping is created in a cloud computing system or a distributed computing system, and the runtime system is implemented on an edge computing platform.

11. A computer implemented method for adapting a simulation of a physical system by a digital twin at runtime, the digital twin utilizing a physics-based model of the physical system defined by a physics-based parameter set, the method comprising:
operating a controllable device of the physical system to execute a process by generating control signals that act on the controllable device to produce a physical input signal to the physical system,
updating parameter values in the physics-based parameter set at discrete time steps during the execution of the process by the controllable device by a method according to claim 1, and
using the updated parameter values determined at each time step to carry out a simulation of the physical system by the digital twin utilizing the physics-based model, until a next update of the parameter values is determined at a subsequent time step during the execution of the process by the controllable device.

12. A non-transitory computer-readable storage medium including instructions that, when processed by a computer, configure the computer to perform the method according to claim 1.

13. A computing apparatus comprising:
a processor; and
a memory storing instructions for automatically tuning a digital twin of a physical system, the digital twin utilizing a physics-based model of the physical system defined by a physics-based parameter set,
wherein the instructions, when executed by the processor, configure the computing apparatus to:
obtain a trained mapping between the physics-based parameter set and a filter coefficient set of an adaptive filter applied to the physical system,
initialize the physics-based parameter set and the filter coefficient set, and
over a series of discrete time steps, iteratively perform at each time step:
compute, by the physics-based model, an output response to a measured physical input signal using current parameter values in the physics-based parameter set,
measure, from the physical system, an output signal produced in response to the physical input signal, and determine an error signal based on the measured output signal and the computed output response,
update the filter coefficient set as a linear function of the error signal, and
determine updated parameter values in the physics-based parameter set from the updated filter coefficient set using the trained mapping.

14. An automation system comprising:
a physical system comprising a controllable device; and
a computing system comprising:
a processor; and
a memory storing instructions for adapting a simulation of the physical system by a digital twin at runtime, the digital twin utilizing a physics-based model of the physical system defined by a physics-based parameter set,
wherein the instructions, when executed by the processor, configure the computing system to:
obtain a trained mapping between the physics-based parameter set and a filter coefficient set of an adaptive filter applied to the physical system,
initialize the physics-based parameter set and the filter coefficient set,
operate the controllable device to execute a process by generating control signals that act on the controllable device to produce a physical input signal to the physical system,
over a series of discrete time steps during the execution of the process by the controllable device, iteratively perform at each time step:
compute, by the physics-based model, an output response based on a measurement of the physical input signal using current parameter values in the physics-based parameter set,
measure, from the physical system, an output signal produced in response to the physical input signal, and determine an error signal based on the measured output signal and the computed output response,
update the filter coefficient set as a linear function of the error signal,
determine updated parameter values in the physics-based parameter set from the updated filter coefficient set using the trained mapping, and
use the updated parameter values in the physics-based parameter set to carry out a simulation of the physical system by the digital twin using the physics-based model.
